(19) United States
(12) Patent Application Publication
(10) Pub. No.: US 2025/0239670 A1
(43) Pub. Date: Jul. 24, 2025

(54) SYSTEM AND METHOD FOR MONITORING A RECHARGEABLE BATTERY

(71) Applicant: VISTEON GLOBAL TECHNOLOGIES INC., Van Buren Township, MI (US)

(72) Inventors: Qun Zhu, Shanghai (CN); Mathew Breton, Westland, MI (US); Tao Wang, Oakland Twp., MI (US)

(73) Assignee: VISTEON GLOBAL TECHNOLOGIES, INC., Van Buren Township, MI (US)

(21) Appl. No.: 18/704,443

(22) PCT Filed: Oct. 25, 2021
(86) PCT No.: PCT/CN2021/126161

§ 371 Date: Apr. 24, 2024

(51) Int. Cl. H01M 10/48; B60L 3/00; H01M 10/42

(52) U.S. Cl. CPC H01M 10/482; B60L 3/0046; H01M 10/4257; H01M 2010/4278

(57) ABSTRACT

A monitoring system for a rechargeable battery and a method of monitoring includes at least one controller and a plurality of sensors. The battery is monitored by one or more of the plurality of sensors. The at least one controller is in communication with the plurality of sensors. The at least one controller includes an instruction set executable in response to a periodic wake-up command from a wake-up mechanism to determine, via the plurality of sensors, a parameter for the battery, evaluate the parameter for the battery and communicate, via a communication medium, the evaluation of the parameter for the battery to the at least one controller.

### INTRODUCTION

A DC power source in the form of a rechargeable battery pack may include one or multiple battery modules that are electrically connected in parallel or in series, depending upon the needs of the system. Each of the battery modules includes one or multiple battery cells, and each battery cell includes one or a plurality of lithium ion electrode pairs that are enclosed within a sealed envelope.

A rechargeable battery pack may be subjected to numerous charge/discharge cycles during its service life. Some charging events may completely charge all of the battery cells. However, some charging events may result in complete charging of some of the battery cells and partial charging of others of the battery cells, leading to charge imbalances.

A battery management system (BMS) may be employed to manage charging and discharging events, including monitoring and managing states of charge of the individual battery cells in an attempt to avoid over-charging of some cells. The BMS provides for the management and monitoring of a rechargeable battery pack, including charge balance management during charging and discharging to prevent one or more of the battery cells of the rechargeable battery pack from overcharging and/or overdischarging, extending battery life, and helping the battery to function properly. Functions of a BMS may include real-time monitoring of physical parameters of the battery, battery status estimation, online diagnosis and early warning, thermal management and so on. Some implementations of the foregoing functions may lead to a battery condition such as overheating, which may be caused by overcharging and/or overdischarging of one of the battery cells.

Current technology has the ability to remotely detect a limited set of information that is pertinent to maintaining the safety of the battery pack, and may be limited to analog sensing of cell voltage and temperatures. Many implementations can only do this while they are fully powered and operational. Some systems can perform limited sensing while operating in a low power mode.

Battery pack thermal propagation detection methods presently monitor and compare parameters with absolute limits, and trigger an alarm only when those limits are exceeded. Furthermore, such methods and systems can draw excessive current when the vehicle is “asleep” to maintain a detection network, thus draining the battery. Some systems and methods do not perform monitoring and/or diagnostics while the vehicle is asleep.

There is a need for improved monitoring, detection and diagnosis of battery conditions, such as when a battery is in a sleep state when deployed on a vehicle with the vehicle being in an OFF state.

There is a need for technology that can work with a variety of analog and digital sensors and perform complex and adaptive analyses during periods of time when the battery is in a low-power state or a sleep state.

### SUMMARY

The concepts described herein provide a system that includes a microcontroller, sensors, and one or more algorithm(s) to provide an active battery cell monitoring system to proactively monitor battery cells to prevent occurrence of thermal propagation events, enable prognostic features, and perform high coverage diagnostics. The system is designed to work in both wired and wireless implementations, and with a various sensors.

An aspect of the disclosure includes an active cell monitoring system for a multi-cell rechargeable battery that includes a plurality of sensors, wherein each cell of the battery is monitored by one of the plurality of sensors, a microcontroller, in communication with the plurality of sensors, and a communication medium. A wake-up mechanism is operative to periodically wake up the microcontroller. The microcontroller including an instruction set, the instruction set being executable, in response to a periodic wake-up command from the wake-up mechanism, to determine, via the plurality of sensors, a parameter for each of the cells of the battery, and evaluate the parameter for each of the cells of the battery. The evaluation of the parameter for each of the cells of the battery is communicated, via the communication medium, to a second controller, such as a controller for a battery management system.

Another aspect of the disclosure includes the instruction set being executable to deactivate the microcontroller subsequent to communicating the evaluation of the parameter for each of the cells of the battery to the second controller.

Another aspect of the disclosure includes the instruction set being executable to evaluate the parameter for each of the cells of the battery by detecting presence of a fault in the battery based upon the evaluation of the parameter for each of the cells of the battery, and communicating the presence of the fault in the battery to the second controller.

Another aspect of the disclosure includes the communication medium being one of a wireless communication link or a hardwired communication link that is arranged to communicate with the second controller.

Another aspect of the disclosure includes the plurality of sensors being one of a voltage sensor, battery temperature sensor, a cell temperature sensor, a pressure sensor, a gas sensor, or an impedance sensor that is arranged to monitor the cells of the battery.

Another aspect of the disclosure includes the instruction set being executable to compare the parameter for each of the cells of the battery with a threshold value for the parameter.

Another aspect of the disclosure includes the instruction set being executable to compare a rate of change of the parameter for each of the cells of the battery with a threshold rate of change for the parameter.

Another aspect of the disclosure includes the multi-cell rechargeable battery being arranged on a vehicle, wherein the instruction set is executed in response to a periodic wake-up command from the wake-up mechanism that occurs during a period when the vehicle is in an off state.

Another aspect of the disclosure includes an active cell monitoring system for a multi-cell rechargeable battery that includes a first plurality of sensors, wherein each cell of the battery is monitored by one of the first plurality of sensors, and a second plurality of sensors, wherein the battery is monitored by the second plurality of sensors. A microcontroller is in communication with the first plurality of sensors and the second plurality of sensors, and a communication medium is arranged to communicate with a second controller. A wake-up mechanism is operative to periodically wake up the microcontroller. The microcontroller includes an instruction set that is executable, in response to a periodic wake-up command from the wake-up mechanism, to determine, via the first plurality of sensors, a first parameter for each of the cells of the battery, and determine, via the second plurality of sensors, a second parameter for the battery. The first and second parameters are evaluated, and the evaluation of the first and second parameters for each of the cells of the battery is communicated to a second controller.

Another aspect of the disclosure includes the instruction set being executable to evaluate the first and second parameters to detect presence of a fault in the battery based upon the evaluation of the first and second parameters of the battery and communicate the presence of the fault in the battery to the second controller.

Another aspect of the disclosure includes the instruction set being executable to communicate the evaluation of the first and second parameters for the cells of the battery to the second controller via one of a wireless communication link or a hardwired communication link.

Another aspect of the disclosure includes the first plurality of sensors being one of a temperature sensor, a pressure sensor, a gas sensor, or a voltage sensor.

Another aspect of the disclosure includes the second plurality of sensors being one of a temperature sensor, a gas sensor, a voltage sensor, or an impedance sensor.

Another aspect of the disclosure includes the instruction set being executable to compare the first parameter for each of the cells of the battery with a threshold value for the parameter, and compare a rate of change of the first parameter for each of the cells of the battery with a threshold rate of change for the first parameter.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 illustrates a cutaway isometric drawing of a multi-cell rechargeable battery pack having a battery management system, in accordance with the disclosure.

FIG. 2 schematically illustrates an embodiment of an active cell monitoring system that is advantageously arranged to monitor and evaluate a multi-cell rechargeable battery pack, in accordance with the disclosure.

FIG. 3 schematically illustrates a logic flowchart that depicts an evaluation of a multi-cell rechargeable battery pack, in accordance with the disclosure.

FIG. 4 schematically illustrates details related to an embodiment of an active cell monitoring system that is advantageously arranged to monitor and evaluate a multi-cell rechargeable battery pack, in accordance with the disclosure.

FIG. 5 schematically illustrates details related to an embodiment of an active cell monitoring system that is advantageously arranged to monitor and evaluate a multi-cell rechargeable battery pack, in accordance with the disclosure.

FIG. 6 schematically illustrates elements of an embodiment of an active cell monitoring system that is advantageously arranged to monitor and evaluate a multi-cell rechargeable battery pack, in accordance with the disclosure.

The appended drawings are not necessarily to scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The use of ordinals such as first, second and third does not necessarily imply a ranked sense of order, but rather may only distinguish between multiple instances of an act or structure.

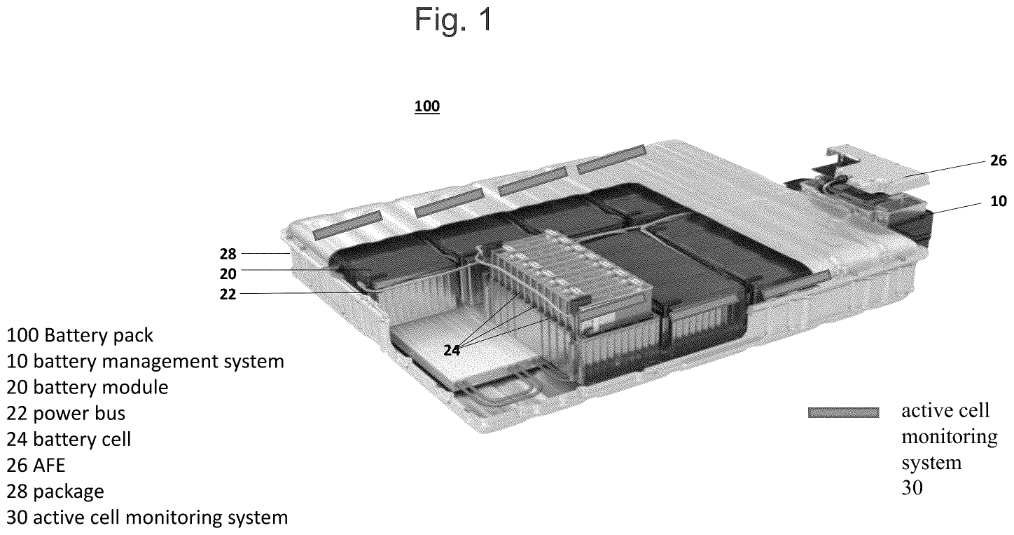

Referring to the drawings, wherein like reference numerals correspond to like or similar components throughout the several Figures, FIG. 1, consistent with embodiments disclosed herein, illustrates a cutaway isometric drawing of a multi-cell rechargeable battery pack (battery pack) 100 having an embodiment of a battery management system (BMS) 10 as described herein. The battery pack 100 and BMS 10 may be deployed on a mobile platform in one embodiment, in the form of a commercial vehicle, industrial vehicle, agricultural vehicle, passenger vehicle, aircraft, watercraft, train, all-terrain vehicle, personal movement apparatus, robot, and the like to accomplish the purposes of this disclosure. Alternatively, the battery pack 100 and BMS 10 may be deployed on a stationary power storage device.

The battery pack 100 is composed of a plurality of battery modules 20 that are arranged in parallel or in series/parallel employing a power bus 22. Each of the plurality of battery modules 20 is composed of a plurality of battery cells 24.

The BMS 10 is arranged to manage and monitor the battery pack 100, including charge balance management during charging and discharging event to prevent one or more of the battery cells 24 of the battery pack 100 from overcharging and/or overdischarging, thus extending battery life, and helping the battery pack 100 to function as intended. Specific roles of the BMS 10 may include monitoring and protecting the battery, estimating battery states, maximizing battery performance, data logging, and reporting out to other controllers. Functions include preventing any cell from going into an overvoltage situation inside the battery pack, which may be achieved by stop charging (giving a turn-off signal to the contactor); preventing the temperature of any cell from exceeding an upper threshold limit by reducing/stopping current flow or by activating the cooling system in the battery pack 100. This protects the battery from a thermal runaway event; prevent any cell from going into an under-voltage situation by limiting/stopping the discharge current; and protecting the battery pack 100 from short circuit and overload situations by opening electrical contactors.

The BMS 10 may include a Safety System on Chip (SoC) that is designed in accordance with an ISO 26262-compliant process to efficiently meet up to ASIL-D requirements. The Safety SoC uses multicores in a diverse lockstep architecture combined with cutting-edge safety technology, such as safe internal communication buses or a distributed memory protection system.

The BMS 10 includes an analog front end device (AFE) 26, which includes analog sensors including, e.g., voltage, current and temperature sensors. The AFE 26 may be an integrated circuit that is integrated into the BMS 10 or in communication with the BMS 10, and is designed to include the analog circuitry required for the design and operation of the BMS 10. It contains voltage inputs to measure the cell voltages of each of the battery cells 24. The AFE 26 also plays a role in triggering the balancing circuitry. The AFE 26 may contain a built-in temperature sensor that is meant for measuring the BMS circuit board temperature. The AFE 26 may have an internal small digital state machine that manages the sequential measurement of voltages present at the input, along with providing a communication interface. Specific functions of the AFE 26 include measuring each cell voltage, measuring cell or board temperature, and providing balancing circuitry for each cell.

The AFE 26 includes components optimized to take advantage of smart partitioning by integrating amplifiers, filters, receive ADCs, and/or transmit path data conversions (DACs), and can be employed to measure voltage connected battery cells in series, module temperatures and perform cell balancing.

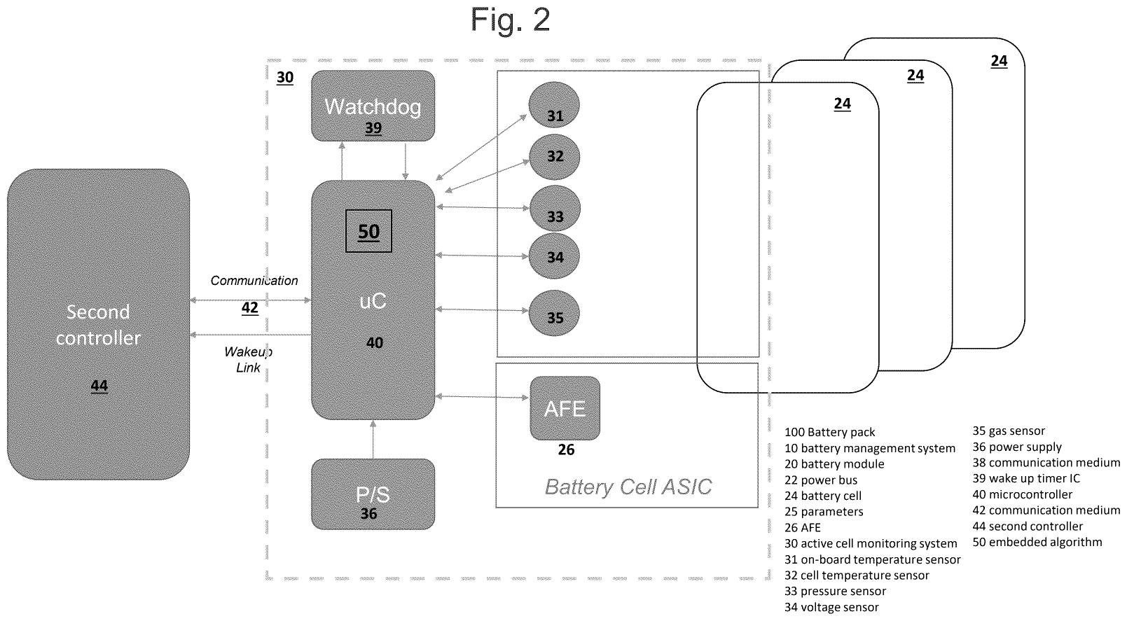

FIG. 2 schematically illustrates an embodiment of an active cell monitoring system 30 that is advantageously arranged to monitor a plurality of the battery cells 24 of the battery pack 100 and BMS 10 of FIG. 1. One or multiple active cell monitoring systems 30 may be arranged to monitor the plurality of battery cells 24. By way of a non-limiting example and as illustrated, there may be an active cell monitoring system 30 arranged to monitor the battery cells 24 in each of the battery modules 20. Other arrangements of the active cell monitoring system 30 may be employed, including, e.g., the active cell monitoring system 30 being arranged to monitor all of the battery cells 24 of the battery pack 100. As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The active cell monitoring system 30 includes a microcontroller 40, one or multiple sensors 31-35, a power supply 36, a circuit watchdog 38, a communication medium 42, and an embedded algorithm 50. In one embodiment, the circuit watchdog 38 includes a wake-up timer integrated circuit (IC) 39, which is a low power IC that periodically wakes up or activates the microcontroller 40, thus enabling the microcontroller 40 to go to sleep, i.e., deactivate to minimize power consumption.

The one or multiple sensors 31-35, includes, in one embodiment, one or more of a voltage sensor 31, a first temperature sensor 32, a second temperature sensor 33, a pressure sensor 34, and a gas sensor 35. Sensors capable of monitoring other battery parameters, e.g., an impedance sensor, may be employed in addition or in substitution for one or more of the aforementioned sensors. The voltage sensor 31 is arranged to monitor cell voltage. The first temperature sensor 32 is arranged to monitor the battery temperature or a circuit board temperature of the AFE 26. The second temperature sensor 33 is arranged to monitor temperature of one of the plurality of battery cells 24. The pressure sensor 34 is arranged to monitor pressure of one of the plurality of battery cells 24. The gas sensor 35 is arranged to monitor concentration(s) of one or more gases, e.g., hydrogen in one embodiment. Other sensors may include pressure and temperature sensors that are arranged to monitor a battery coolant system, and impedance sensors arranged to monitor electrical isolation of the cells and/or the power bus.

The communication medium 42 may be a hardwired communication link, e.g., a communication bus such as a serial peripheral interface (SPI) bus. Alternatively, the communication medium 42 may be a wireless communication link.

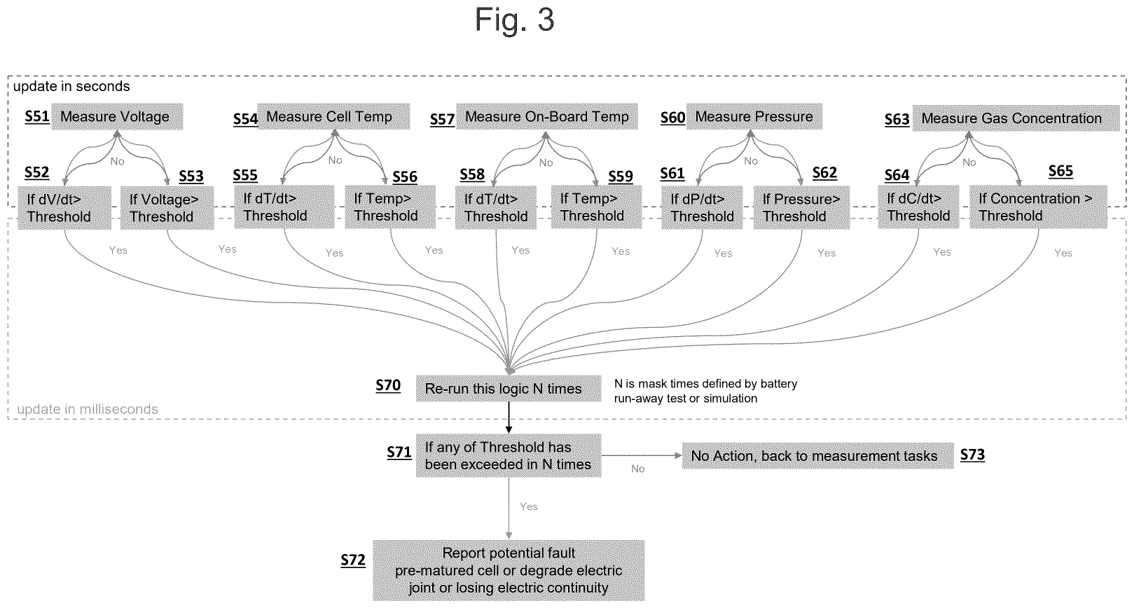

The microcontroller 40 includes the embedded algorithm 50, which may be in the form of one or multiple executable instruction sets. The embedded algorithm 50 may begin execution in the microcontroller 40 in response to a periodically-sent wake up message, e.g., in response to a signal from the wake-up timer IC 39. Upon waking up, the microcontroller 40 interrogates or otherwise gathers information from the multiple sensors 31-35 to determine one or multiple parameters 25 for the battery cells 24, the battery module 20, and the battery pack 100. The parameters 25 for the battery cells 24 are evaluated as part of the embedded algorithm 50, with the evaluation being communicated, via the communication medium 42 to a second controller 44, such as a controller of the battery management system 10. Details related to the evaluation executed by the embedded algorithm 50 are described with reference to FIG. 3.

The term “microcontroller” and related terms such as controller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a waveform (e.g., electrical, optical, magnetic, mechanical or electromagnetic), such as DC, AC, sinusoidal-wave, triangular-wave, square-wave, vibration, and the like, that is capable of traveling through a medium.

A parameter is defined as a measurable quantity that represents a physical property of a device or other element that is discernible using one or more sensors and/or a physical model. A parameter can have a discrete value, e.g., either “1” or “0”, or can be infinitely variable in value.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

FIG. 3 schematically illustrates a logic flowchart that depicts the evaluation that is executed by the embedded algorithm 50. Upon activation, e.g., in response to a signal from the wake-up timer IC 39, the microcontroller 40 interrogates or otherwise gathers information from the multiple sensors 31-35 to determine one or multiple parameters 25 for the battery cells 24, the battery module 20, and the battery pack 100.

This includes measuring cell voltage (S51) with the voltage sensor 31, and determining a time-rate of change in the voltage based upon a previous observation. When the cell voltage (S51) is less than a voltage threshold (S52) and the time-rate of change in the voltage is less than a threshold rate of change (S53), this iteration of this portion of the evaluation ends. When the cell voltage (S51) is greater than the voltage threshold (S52) or the time-rate of change in the cell voltage is greater than the threshold rate of change (S53), this result is reported out for this iteration (S70).

This further includes measuring cell temperature (S54) with the first temperature sensor 32, and determining a time-rate of change in the cell temperature based upon a previous observation. When the cell temperature (S54) is less than a first temperature threshold (S55) and the time-rate of change in the cell temperature is less than a threshold rate of change (S56), this iteration of this portion of the evaluation ends. When the cell temperature (S54) is greater than the first temperature threshold (S55) or the time-rate of change in the cell temperature is greater than the threshold rate of change (S56), this result is reported out for this iteration (S70).

This further includes measuring circuit board temperature (S57) with the second temperature sensor 33, and determining a time-rate of change in the circuit board temperature based upon a previous observation. When the circuit board temperature (S57) is less than a second temperature threshold (S58) and the time-rate of change in the circuit board temperature is less than a threshold rate of change (S59), this iteration of this portion of the evaluation ends. When the circuit board temperature (S57) is greater than the second temperature threshold (S58) or the time-rate of change in the circuit board temperature is greater than the threshold rate of change (S59), this result is reported out for this iteration (S70).

This further includes measuring cell pressure (S60) with the pressure sensor 34, and determining a time-rate of change in the cell pressure based upon a previous observation. When the cell pressure (S60) is less than a pressure threshold (S61) and the time-rate of change in the cell pressure is less than a threshold rate of change (S62), this iteration of this portion of the evaluation ends. When the cell pressure (S60) is greater than the pressure threshold (S61) or the time-rate of change in the cell pressure is greater than the threshold rate of change (S62), this result is reported out for this iteration (S70).

This may further include measuring a gas concentration (S63) with the gas sensor 35, and determining a time-rate of change in the gas concentration based upon a previous observation. When the gas concentration (S63) is less than a gas concentration threshold (S64) and the time-rate of change in the gas concentration is less than a threshold rate of change (S65), this iteration of this portion of the evaluation ends. When the gas concentration (S63) is greater than the gas concentration threshold (S64) or the time-rate of change in the gas concentration is greater than the threshold rate of change (S65), this result is reported out for this iteration (S70).

Each of the aforementioned thresholds are calibrated values that may be application-specific and determined during development, or may be otherwise determined.

The aforementioned evaluation steps S51 through S65 are executed each iteration, with a quantity of N iterations being executed during each activation of the microcontroller 40.

The results from the evaluation steps S51 through S65 are subjected to an analysis (S71).

The evaluation of the parameters for the cells of the battery are communicated to the controller. This includes communicating occurrence of a fault with the battery pack 100 when the results from the evaluation steps S51 through S65 indicate that one or more of the cell voltage, the time-rate of change in the cell voltage, the cell temperature, the time-rate of change in the cell temperature, the circuit board temperature, the time-rate of change in the circuit board temperature, the cell pressure, the time-rate of change in the cell pressure, the gas concentration, or the time-rate of change in the gas concentration is greater than its corresponding threshold (S72). Alternatively, this includes communicating absence of a fault with the battery pack 100 when the results from the evaluation steps S51 through S65 indicate that none of the cell voltage, the time-rate of change in the cell voltage, the cell temperature, the time-rate of change in the cell temperature, the circuit board temperature, the time-rate of change in the circuit board temperature, the cell pressure, the time-rate of change in the cell pressure, the gas concentration, and the time-rate of change in the gas concentration is greater than its corresponding threshold (S73).

The instructions may be implemented through a computer algorithm, machine executable code, non-transitory computer-readable medium, or software instructions programmed into a suitable programmable logic device(s) of the vehicle, or a remote server in communication with the vehicle computing system, a mobile device communicating with the vehicle computing system and/or server, other controller in the vehicle, or a combination thereof. Although the various steps shown in the flowchart diagram appear to occur in a chronological sequence, at least some of the steps may occur in a different order, and some steps may be performed concurrently or not at all.

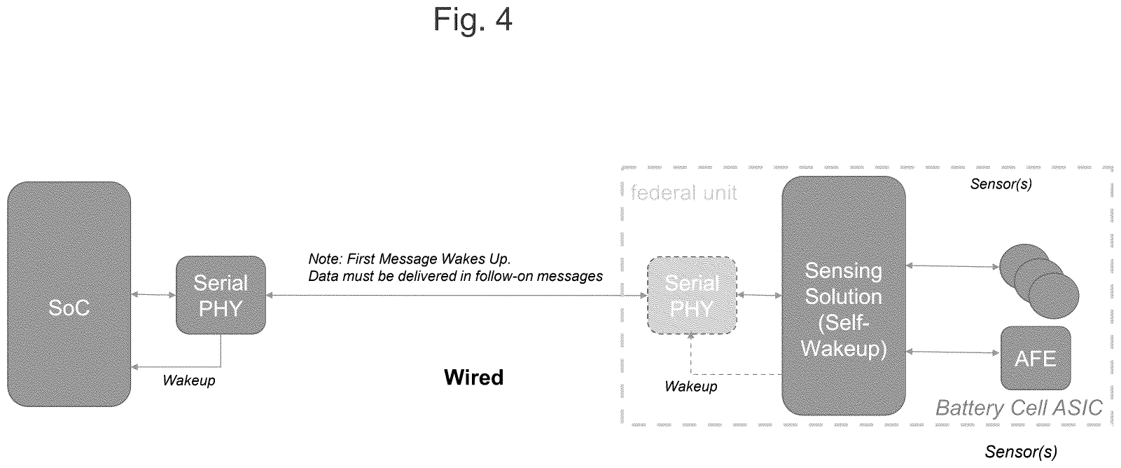

FIG. 4 schematically illustrates details related to an embodiment of the active cell monitoring system to monitor and evaluate a multi-cell rechargeable battery pack. The active cell monitoring system includes microcontroller, sensors, power supply, circuit watchdog, and communication medium in the form of a hardwired communication link, e.g., a communication bus such as a serial peripheral interface (SPI) bus. An embedded algorithm may begin execution in the microcontroller in response to a periodically-sent wake up message, e.g., in response to a signal from an internal wake-up timer IC. Upon waking up, the microcontroller interrogates or otherwise gathers information from the multiple sensors to determine one or multiple parameters for the battery cells, the battery module, and the battery pack. The parameters for the battery cells are evaluated as part of the embedded algorithm, with the evaluation being communicated, via the communication medium to a second controller.

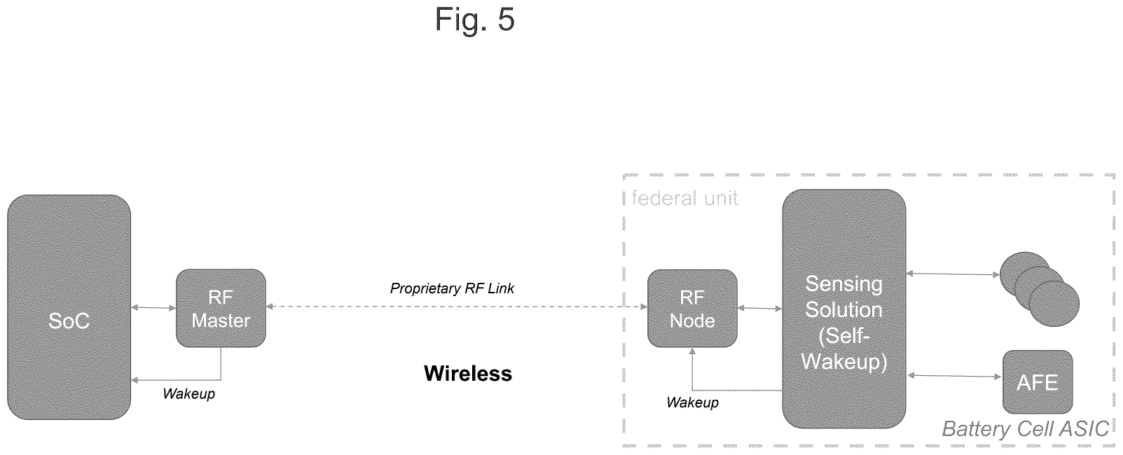

FIG. 5 schematically illustrates details related to an embodiment of the active cell monitoring system to monitor and evaluate a multi-cell rechargeable battery pack. The active cell monitoring system includes microcontroller, sensors, power supply, circuit watchdog, and communication medium in the form of a wireless communication link, e.g., a proprietary RF (radiofrequency) communication link. An embedded algorithm may begin execution in the microcontroller in response to a periodically-sent wake up message, e.g., in response to a signal from an internal wake-up timer IC. Upon waking up, the microcontroller interrogates or otherwise gathers information from the multiple sensors to determine one or multiple parameters for the battery cells, the battery module, and the battery pack. The parameters for the battery cells are evaluated as part of the embedded algorithm, with the evaluation being communicated, via the communication medium to a second controller.

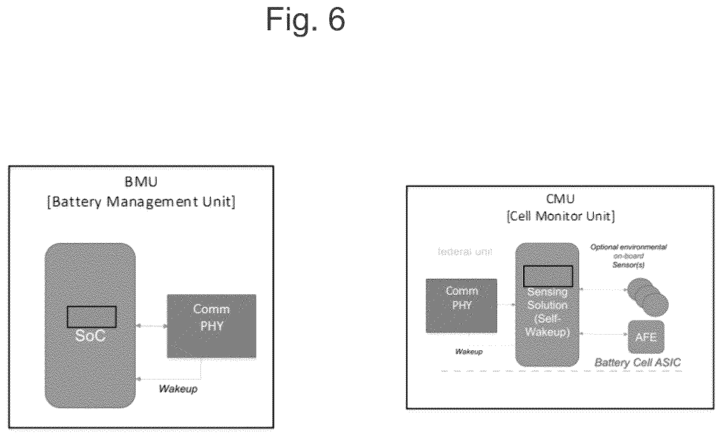

FIG. 6 schematically illustrates elements of an embodiment of an active cell monitoring system, including devices in the form of a battery management unit (BMU) and a cell monitoring unit (CMU). The battery management unit (BMU) and the cell monitoring unit (CMU) are configured to be modular devices that can be arranged to plug-and-play in existing systems to effect the active cell monitoring scheme described herein. The communication medium may be a hardwired communication link, e.g., a communication bus such as a serial peripheral interface (SPI) bus. Alternatively, the communication medium may be a wireless communication link.

The concepts described herein provide an integrated smart battery management system that employs a microcontroller, software and sensors to monitor the individual cells of the battery, the battery, and the local environment to detect changes that may indicate occurrence of a fault.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. An active cell monitoring system for a multi-cell rechargeable battery, comprising:
a plurality of sensors, wherein each cell of the battery is monitored by one of the plurality of sensors;
a microcontroller, in communication with the plurality of sensors;
a communication medium; and
a wake-up mechanism operative to periodically wake up the microcontroller; and
the microcontroller including an instruction set, the instruction set being executable, in response to a periodic wake-up command from the wake-up mechanism, to:
determine, via the plurality of sensors, a parameter for each of the cells of the battery;
evaluate the parameter for each of the cells of the battery; and
communicate, via the communication medium, the evaluation of the parameter for each of the cells of the battery to a second controller.

2. The active cell monitoring system of claim 1, further comprising the instruction set being executable to deactivate the microcontroller subsequent to communicating the evaluation of the parameter for each of the cells of the battery to the second controller.

3. The active cell monitoring system of claim 1, wherein the instruction set being executable to evaluate the parameter for each of the cells of the battery comprises the instruction set being executable to:
detect presence of a fault in the battery based upon the evaluation of the parameter for each of the cells of the battery; and
communicate the presence of the fault in the battery to the second controller.

4. The active cell monitoring system of claim 1, wherein the communication medium comprises one of a wireless communication link or a hardwired communication link that is arranged to communicate with the second controller.

5. The active cell monitoring system of claim 1, wherein the plurality of sensors comprises one of a voltage sensor, battery temperature sensor, a cell temperature sensor, a pressure sensor, a gas sensor, or an impedance sensor.

6. The active cell monitoring system of claim 1, wherein the instruction set being executable to evaluate the parameter for each of the cells of the battery comprises the instruction set being executable to compare the parameter for each of the cells of the battery with a threshold value for the parameter.

7. The active cell monitoring system of claim 1, wherein the instruction set being executable to evaluate the parameter for each of the cells of the battery comprises the instruction set being executable to compare a rate of change of the parameter for each of the cells of the battery with a threshold rate of change for the parameter.

8. The active cell monitoring system of claim 1, wherein the multi-cell rechargeable battery is arranged on a vehicle; and wherein the instruction set is executed in response to a periodic wake-up command from the wake-up mechanism that occurs during a period when the vehicle is in an off state.

9. An active cell monitoring system for a multi-cell rechargeable battery, comprising:
a first plurality of sensors, wherein each cell of the battery is monitored by one of the first plurality of sensors;
a second plurality of sensors, wherein the battery is monitored by the second plurality of sensors;
a communication medium;
a microcontroller, in communication with the first plurality of sensors and the second plurality of sensors; and
a wake-up mechanism operative to periodically wake up the microcontroller;
the microcontroller includes an instruction set, the instruction set being executable, in response to a periodic wake-up command from the wake-up mechanism, to:
determine, via the first plurality of sensors, a first parameter for each of the cells of the battery;
determine, via the second plurality of sensors, a second parameter for the battery;
evaluate the first and second parameters; and
communicate the evaluation of the first and second parameters for each of the cells of the battery to a second controller.

10. The active cell monitoring system of claim 9, further comprising the instruction set being executable to deactivate the microcontroller subsequent to communicating the evaluation of the first and second parameters to the second controller.

11. The active cell monitoring system of claim 9, wherein the instruction set being executable to evaluate the first and second parameters comprises the instruction set being executable to:
detect presence of a fault in the battery based upon the evaluation of the first and second parameters of the battery; and
communicate the presence of the fault in the battery to the second controller.

12. The active cell monitoring system of claim 9, further comprising the instruction set being executable to communicate the evaluation of the first and second parameters for the cells of the battery to the second controller via one of a wireless communication link or a hardwired communication link.

13. The active cell monitoring system of claim 9, wherein the first plurality of sensors comprises one of a temperature sensor, a pressure sensor, a gas sensor, or a voltage sensor.

14. The active cell monitoring system of claim 9, wherein the second plurality of sensors comprises one of a temperature sensor, a gas sensor, a voltage sensor, or an impedance sensor.

15. The active cell monitoring system of claim 9, wherein the instruction set being executable to evaluate the first parameter for each of the cells of the battery comprises the instruction set being executable to compare the first parameter for each of the cells of the battery with a threshold value for the parameter.

16. The active cell monitoring system of claim 9, wherein the instruction set being executable to evaluate the parameter for each of the cells of the battery comprises the instruction set being executable to compare a rate of change of the first parameter for each of the cells of the battery with a threshold rate of change for the first parameter.

17. The active cell monitoring system of claim 9, wherein the multi-cell rechargeable battery is arranged on a vehicle; and wherein the instruction set is executed in response to a periodic wake-up command from the wake-up mechanism that occurs during a period when the vehicle is in an off state.
